(19) United States
(12) Patent Application Publication
(10) Pub. No.: US 2011/0059667 A1
(43) Pub. Date: Mar. 10, 2011

(54) COVER WITH A SPRAY ON FABRIC

(75) Inventors: Mike Meyer, Tillsonburg (CA); Gregg Ronald Laframboise, Windsor (CA); Bonnie Lake Coker, Whitmore Lake, MI (US); Daniel Koester, Ann Arbor, MI (US); Daniel J. Sakkinen, Highland, MI (US); Eric B. Michalak, Westland, MI (US); Ornela Zekavica, Northville, MI (US); Brent T. Hodge, Brighton, MI (US); Daniel J. LaFlamme, Wixom, MI (US); Nicholas L. Petouhoff, South Lyon, MI (US)

(73) Assignee: Johnson Controls Technology Company, Holland, MI (US)

(21) Appl. No.: 12/878,116

(22) Filed: Sep. 9, 2010

Related U.S. Application Data
(60) Provisional application No. 61/240,693, filed on Sep. 9, 2009.

(51) Int. Cl. B32B 5/24; B32B 5/02; B05D 1/12

(52) U.S. Cl. 442/370; 442/327; 427/180

(57) ABSTRACT

The present invention relates to a process for the production of a car interior part with a base layer and a fabric layer and a car interior part comprising these layers.

### CLAIM OF PRIORITY

This application claims priority to U.S. Provisional Application Ser. No. 61/240,693 titled “Cover with a Spray on Fabric” filed Oct. 9, 2009, the entire contents thereof are incorporated herein by reference

### FIELD OF INVENTION

The present invention relates to a process for the production of a car interior part with a base layer and a fabric layer and a car interior part comprising these layers.

### BACKGROUND OF THE INVENTION

Car interior parts for example vehicle seats nowadays, in most cases, comprise a base layer and a fabric layer. This fabric layer can be the cover of the seat and/or a layer to reinforce the base layer.

There is an ongoing effort to reduce the production time of such car interior parts.

It was therefore the problem of the present invention to provide a process for the production of a car interior part that is more efficient than the processes according to the state of the art.

Another problem of the present invention is to provide a car interior part which is produced more efficiently and/or more easily.

### SUMMARY OF THE INVENTION

The problem is solved with a process for the production of a car interior part with a base layer and a fabric layer, whereas the fabric layer is a spray on layer.

The present invention relates to the process of the production of car interior part. This car interior part can be any part within the interior of a car, for example a door panel, a dashboard, a seat, a trim or the like.

This car interior part comprises a base layer which is preferably a foam layer, more preferably a polyurethane foam layer. Preferably, the base layer is a cushion.

Additionally, the car interior part comprises a fabric layer which is preferably connected, for example by material engagement or mechanically, to the base layer. The spray on fabric layer can be used as a backing (SNP) for the base layer, especially the foam layer, and/or as a cover for the base layer.

This fabric layer is, according to the present invention, a spray on layer; i.e. the fabric material is sprayed on at least parts of the surface of the base layer and cures at least partially on this surface. During adhesion on the surface and/or while curing, a material engagement between the fabric and the surface of the base layer takes place. The spray on fabric is a non woven coating, which preferably comprises fibers.

The spray on fabric can be applied in one or more layers. The thickness of the layers can be varied per layer and/or within each layer.

The spray on fabric can be applied with a spray gun.

This fabric layer preferably covers the base layer at least partially.

Preferably, the fabric layer is applied on the base layer as an aerosol, more preferably in a spraying booth. Fabric material, which does not adhere to the base layer is preferably sucked off and preferably recycled.

In a preferred embodiment, the spray on substance comprises a binding substance, an adhesive and/or an inorganic substance. The binding substance improves the binding between the fabric layer and the base layer. The adhesive substance assists in adhesion of the fabric to the surface of the base layer. The inorganic substance improves the fire resistance of the resulting car interior part.

Another embodiment of the present invention is a car interior part with a base layer and a fabric layer, whereas the fabric layer is a spray on layer.

The disclosure made for the inventive process also applies for the inventive car interior part and vice versa.

Preferably, the base layer is a foam layer, more preferably a polyurethane foam layer.

Preferably, the spray on fabric layer covers the base layer at least partially.

Preferably, the spray on fabric material comprises a binding substance, an adhesive and/or inorganic substance.

The spray on fabric can be part of any item within a car interior. Preferably, the car interior part is a part of a seat. Here the spray on fabric can be the entire seat cover, part of the seat cover, a reinforcement of the seat cover and/or a pocket, for example a map pocket. Preferably, the spray on fabric is applied locally on the foam, the metal structure of the seat and/or inside the seat cover, to improve the comfort of the seat occupant, for example as a bolster and/or the support for the seat occupant and/or as a reinforcement material. The spray on fabric can be applied on the foam and/or the support.

In yet another preferred embodiment the spray on fabric is applied in areas to reinforce the cover, especially locally.

Preferably, the spray on fabric is used in areas to avoid pinch points, for example in the area of the recliner of a vehicle seat.

Preferably, the spray on fabric is applied in areas over switches or any other device.

The spray on fabric can be used to simplify the trim cover. The spray on cover can be applied locally, for example prayed over certain parts of the foam.

The spray on fabric can also be applied to arm rests, head restrain, a dash board, a door trim, an over head trim or the like. The above said also applies to these embodiments of the present invention.

In another preferred embodiment, the spray on cover is used to repair an interior part, for example after an air bag activation, a repair a rip, to cover a stain, to a cover a burn mark etc.

The spray on fabric may comprise and/or cover a scented material.

### BRIEF DESCRIPTION OF THE DRAWINGS

The invention is now explained according to FIGS. 1-10. These explanations do not limit the scope of protection.

FIG. 1 shows a first embodiment of the present invention.

FIG. 2 shows a second embodiment of the present invention.

FIG. 3 shows a tailor-made seat.

FIG. 4 shows a seat with a pocket.

FIG. 5 shows a seat-cover with a flexible zone.

FIG. 6 shows a seat with a spray-on flap.

FIG. 7 shows a seat with a spray-on trim.

FIG. 8 shows a seat with an electric-/electronic-component.

FIG. 9 shows seat-repair.

FIG. 10 shows a tool.

### DETAILED DESCRIPTION OF THE INVENTION

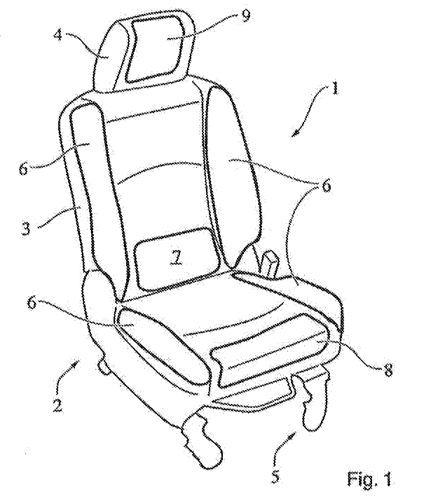

FIG. 1 shows a first embodiment of the present invention, a vehicle seat 1, which comprises a seat base 2 and a backrest 3. At the top of the backrest, a headrest 4 is provided. The seat is connected to the body of the vehicle with a seat track 5. The structure of the seat is covered by a trim and usually under the trim a foam-layer is provided. According to the present invention, the inventive seat comprises several spray on areas, in which a spray on fabric is applied locally on the seat-structure, a foam-layer and/or the trim in order to, for example increase the firmness, the safety and/or the comfort of the bolsters 6, the lumbar 7, the thigh support 8 and/or the headrest 9.

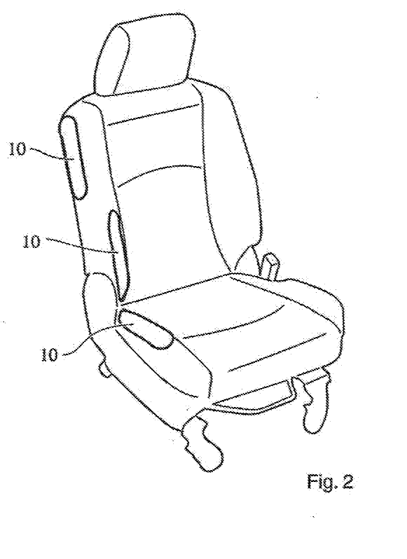

FIG. 2 shows another embodiment of the present invention. In this example, the spray on fabric 10 is also applied locally in order to improve the comfort of the seat and/or as a reinforcement material. The spray on cover can be applied on the metal structure, the foam and/or the cover of the seat.

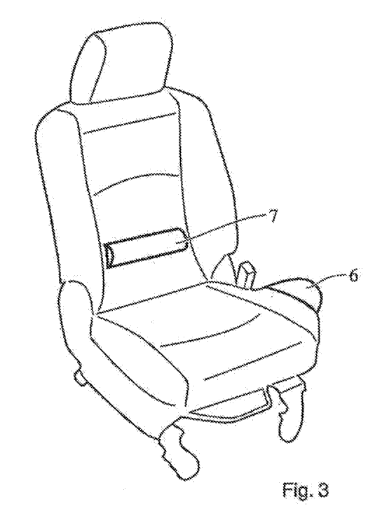

FIG. 3 shows yet another embodiment of the present invention. Here, the spray on fabric material is applied in the area of the lumbar support 7 in order to increase the comfort of the seat. Furthermore, the spray on fabric can be applied for example at the side-custom-bolsters 6 in order to increase the comfort and/or the safety of the seat occupant. Again, the spray on fabric can be applied to the foam and/or the cover itself. With the spray on fabric, a especially locally, tailor-made seat can be manufactured. For example the lumbar and/or the bolsters are shaped specifically to the needs of the customer.

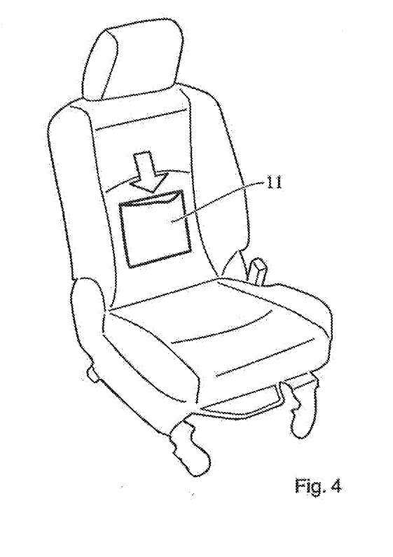

FIG. 4 shows another embodiment of the present invention. Here, the spray on fabric is sprayed on the cover and then opened on one side in order to produce a pocket 11, for example a seat pocket, for example for a map or the like.

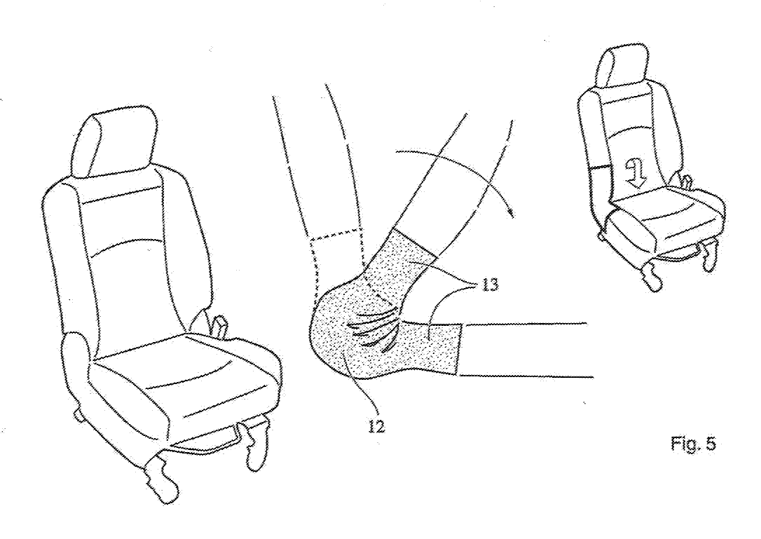

FIG. 5 shows yet another embodiment of the present invention. Here, the spray on cover is applied over pinch points 12 in order to improve the structure of the cover. The spray on cover can be fixed locally 13 to the existing cover and/or the seat and can be lose or flexible in other areas. The spray on fabric can be applied inside or outside the seat cover.

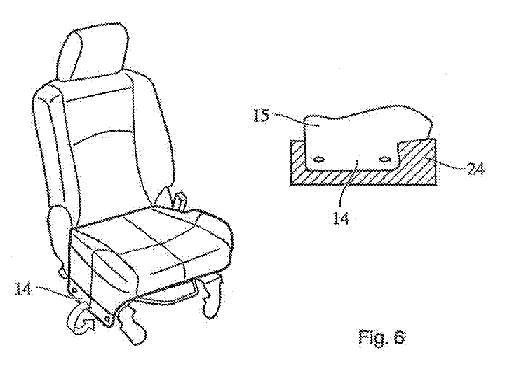

FIG. 6 shows yet another embodiment of the present invention. Here, the spray on fabric is used as a flap 14 to cover certain parts of the seat structure. Preferably, the entire seat cover is made as a spray on fabric. Therefore, the cushion—or back foam 15 sits on a fixture to get sprayed with the spray on fabric. The flap 14 is preferably formed into the fixture 24. The lower end of the flap can be connected to the structure of the seat and/or the seat-track.

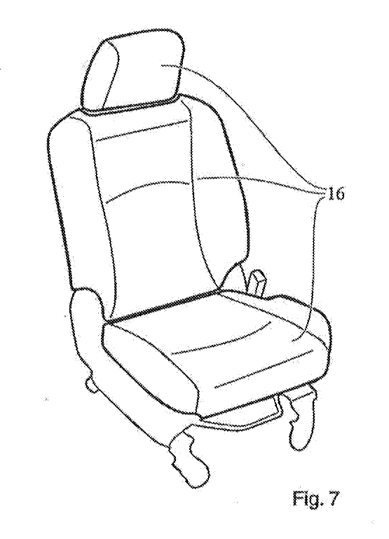

FIG. 7 shows an application where the spray on fabric is directly applied to the foam of a seat as a trim 16, an armrest, a dashboard, a door trim or an overhead structure.

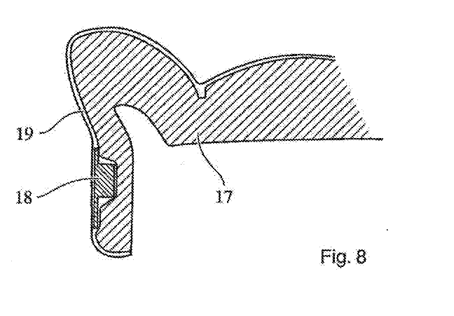

FIG. 8 shows an embodiment in which an electric-, or electronic-component 18, like a switch, is added to the seat and is covered with spray on fabric to, for example, hold the switches in place and/or to protect the switch against moisture, dirt and/or mechanical impact. The switches can be part of a seat heating system, a climate control system and/or to actuate the position or the shape of the seat.

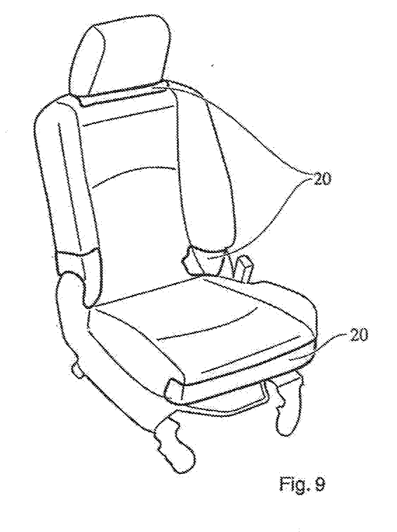

FIG. 9 shows yet another embodiment of the present invention, the spray on fabric 20 can be used to repair existing seats, for example to blend out rat holes, to repair rips, to cover stains and/or burn holes. And yet another embodiment of the present invention, the spray on fabric is used to simplify the trim of a car interior. Thus, complex sewing patterns can be avoided.

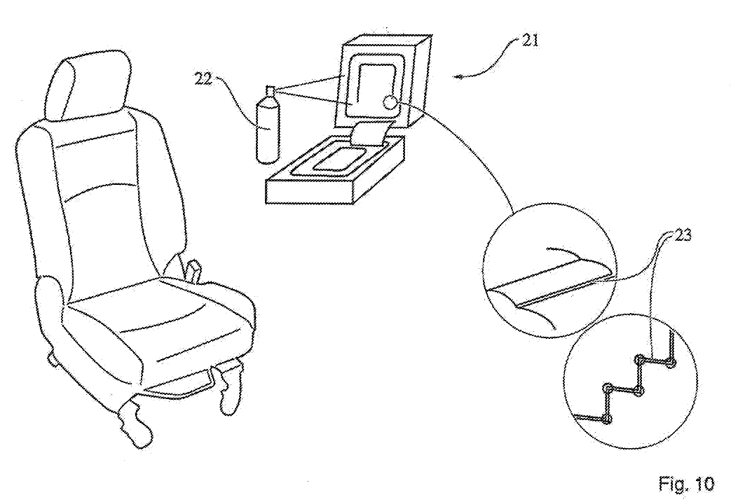

FIG. 10 shows an embodiment of the inventive process. Here, the spray on fabric is sprayed at least locally into a dye 21 in order to produce an interior fabric-cover or in order to cover parts of the dye with the spray on fabric, for example in order to simulate a seam or stitches in the tool. After the spray on fabric has been applied to the tool, the tool is filled with forming material, which is formed in the dye. Resulting is an at least partially fabric coated foam part. The tool may comprise a structured surface.

### LIST OF REFERENCE SIGNS

1 vehicle seat
2 seat-base
3 backrest
4 headrest
5 seat track
6 spray on fabric at the bolster
7 spray on fabric at the lumbar
8 spray on fabric as thigh support
9 spray on layer at the headrest
10 spray on fabric at the structure
11 map pocket
12 pinch point
13 fixing area
14 flap
15 cushion
16 trim
17 foam
18 electric-, electronic-component, switch
19 spray on fabric
20 repair-area
21 tool
22 spray-on-liquid
23 simulated seam
24 fixture

1. Process for the production of a car interior part with a base layer and a fabric layer, whereas the fabric layer is a spray on layer.

2. Process according to claim 1, wherein the layer is sprayed on the base layer after the base layer is formed.

3. Process according to claim 2, wherein the base layer is a foam layer.

4. Process according to claim 3, wherein the foam layer is a polyurethane foam layer.

5. Process according to claim 1, wherein the fabric layer covers the base layer at least partially.

6. Process according to claim 1, wherein the fabric layer is applied as an aerosol.

7. Process according to claim 6, wherein the spray on substance comprises a binding substance.

8. Process according to claim 7, wherein the spray on substance comprises an adhesive.

9. Process according to claim 6, wherein the spray on substance comprises an inorganic substance.

10. Process according to claim 7, wherein the spray on substance comprises an inorganic substance.

11. Car interior part with a base layer and a fabric layer, whereas the fabric layer is a spray on layer.

12. Car interior part to claim 11, wherein the base layer is a foam layer, preferably a polyurethane foam layer.

13. Car interior part to claim 11, wherein the foam layer is a polyurethane foam layer.

14. Car interior part according to claim 13, wherein the fabric layer covers the base layer at least partially.

15. Car interior part according to claim 11, wherein the fabric layer comprises a binding substance.

16. Car interior part according to claim 12, wherein the fabric layer comprises a binding substance.

17. Car interior part according to claim 11, wherein the fabric layer comprises an adhesive.

18. Car interior part according to claim 12, wherein the fabric layer comprises an adhesive.

19. Car interior part according to claim 11, wherein the fabric layer comprises an inorganic substance.

20. Car interior part according to claim 11 being part of a seat, a dashboard, a door trim and/or an over head trim.
